(19) United States
(12) Patent Application Publication
(10) Pub. No.: US 2017/0111394 A1
(43) Pub. Date: Apr. 20, 2017

(54) INFORMATION MANAGEMENT APPARATUS, INFORMATION MANAGEMENT SYSTEM, AND COMPUTER-READABLE RECORDING MEDIUM

(71) Applicant: Satoru Sugishita, Kanagawa (JP)

(72) Inventor: Satoru Sugishita, Kanagawa (JP)

(73) Assignee: Ricoh Company, Ltd., Tokyo (JP)

(21) Appl. No.: 15/288,956

(22) Filed: Oct. 7, 2016

(30) Foreign Application Priority Data
Oct. 14, 2015 (JP) 2015202885

(51) Int. Cl. H04L 29/06

(52) U.S. Cl. CPC H04L 63/20; H04L 63/10

(57) ABSTRACT

An information management apparatus includes: a policy table, in which a function, the function being necessary to provide a client device with security, and security setting values of the function, the security setting values being defined depending on an interface specific to the client device, are recorded such that the function is associated with one of the security setting values for each of levels of the security; a client-communication processing unit configured to perform communication with the client device; a server-communication processing unit configured to communicate with a server, the server issuing a change request requesting for changing a record in the policy table; and a policy-information management unit configured to change the record in the policy table in accordance with the change request.

### CROSS-REFERENCE TO RELATED APPLICATIONS

The present application claims priority under 35 U.S.C. §119 to Japanese Patent Application No. 2015-202885 filed Oct. 14, 2015. The contents of which are incorporated herein by reference in their entirety.

### BACKGROUND OF THE INVENTION

1. Field of the Invention

The present invention relates generally to information management apparatuses, information management systems, and computer-readable recording media.

2. Description of the Related Art

Various devices, e.g., personal computers (PCs), MFPs (multifunction peripherals), and smartphones, are increasingly network-connected today. Therefore, there is increasing attention to security of these networked devices and a need for a method for securely using a wide variety of networked devices.

Japanese Unexamined Patent Application Publication No. 2014-219962 (Patent Document 1) discloses a security management system that automatically changes security-setting-value information concerning a plurality of client devices based on a definition table where security setting values are defined.

Today, while new networked devices are emerging on a daily basis, the number of troubles resulting from security vulnerability is increasing. Under the circumstances, there is a need for a technique that allows using networked devices securely by quickly adapting to latest devices and latest security information.

However, the technique disclosed in Patent Document 1 is disadvantageous in that, because the security setting values cannot be changed flexibly, in a case where a new, unknown client emerges, the new client cannot be included in devices, security of which is managed by the security management system. The technique is disadvantageous also in that the security setting values cannot be changed easily when a new security technique or function emerges.

Therefore, there is a need for an information management apparatus that can provide increased convenience and extensibility by flexibly configuring security settings of client devices, security of which is managed by the information management apparatus, to adapt to new management requirement.

### SUMMARY OF THE INVENTION

According to exemplary embodiments of the present invention, there is provided an information management apparatus comprising: a policy table, in which a function, the function being necessary to provide a client device with security, and security setting values of the function, the security setting values being defined depending on an interface specific to the client device, are recorded such that the function is associated with one of the security setting values for each of levels of the security; a client-communication processing unit configured to perform communication with the client device; a server-communication processing unit configured to communicate with a server, the server issuing a change request requesting for changing a record in the policy table; and a policy-information management unit configured to change the record in the policy table in accordance with the change request.

Exemplary embodiments of the present invention also provide an information management system, in which a client device and a server are network-connected via an information management apparatus, the information management system comprising: a policy table, in which a function, the function being necessary to provide the client device with security, and security setting values of the function, the security setting values being defined depending on an interface specific to the client device, are recorded such that the function is associated with one of the security setting values for each of levels of the security; a client-communication processing unit configured to perform communication with the client device; a server-communication processing unit configured to communicate with the server, the server issuing a change request requesting for changing a record in the policy table; and a policy-information management unit configured to change the record in the policy table in accordance with the change request.

Exemplary embodiments of the present invention also provide a non-transitory computer-readable recording medium containing instructions that, when executed by an information management apparatus including a policy table, in which a function, the function being necessary to provide a client device with security, and security setting values of the function, the security setting values being defined depending on an interface specific to the client device, are recorded such that the function is associated with one of the security setting values for each of levels of the security, a client-communication processing unit configured to perform communication with the client device, and a server-communication processing unit configured to communicate with a server, the server issuing a change request requesting for changing a record in the policy table, cause the information management apparatus to perform processing comprising changing the record in the policy table in accordance with the change request.

### BRIEF DESCRIPTION OF THE DRAWINGS

FIG. 1 is a system configuration diagram of an information management system including an information management apparatus according to an embodiment of the present invention;

FIG. 2 is a functional block diagram illustrating an internal configuration of the information management apparatus according to the present embodiment;

FIG. 3 is a block diagram describing operations to add a new interface performed by the information management apparatus according to the present embodiment;

FIG. 4 is a sequence diagram describing the operations to add a new interface performed by the information management apparatus according to the present embodiment;

FIG. 5 is a block diagram describing operations to add a new security level performed by the information management apparatus according to the present embodiment;

FIG. 6 is a sequence diagram describing the operations to add a new security level performed by the information management apparatus according to the present embodiment;

FIG. 7 is a block diagram describing operations to add a new function performed by the information management apparatus according to the present embodiment;

FIG. 8 is a sequence diagram describing the operations to add a new function performed by the information management apparatus according to the present embodiment;

FIG. 9 is a sequence diagram describing operations to display a policy table and change a security setting value performed by the information management apparatus according to the present embodiment; and

FIG. 10A, FIG. 10B, and FIG. 10C are diagrams describing policy tables of the information management apparatus according to the present embodiment.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, an and the are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Exemplary embodiments of the present invention are described in detail below with reference to the accompanying drawings. In the drawings, like reference numerals refer to identical or corresponding parts, and description of such parts is simplified or omitted as appropriate. It should be noted that the embodiments of the present invention, which are described herein, are not intended to limit the present invention.

An information management apparatus according to an aspect of the present invention is characterized in that a policy table, which is for managing security setting values of client devices, is dynamically changeable. Specifically, the information management apparatus can dynamically change interface information, which is for use in processing communication, and security policy information, in which a security function is associated with one of security setting values for each of security levels. The policy table is automatically created based on the security policy information. The information management apparatus configured as described above can provide increased convenience and extensibility. Features of the present invention are described in detail below with reference to the drawings.

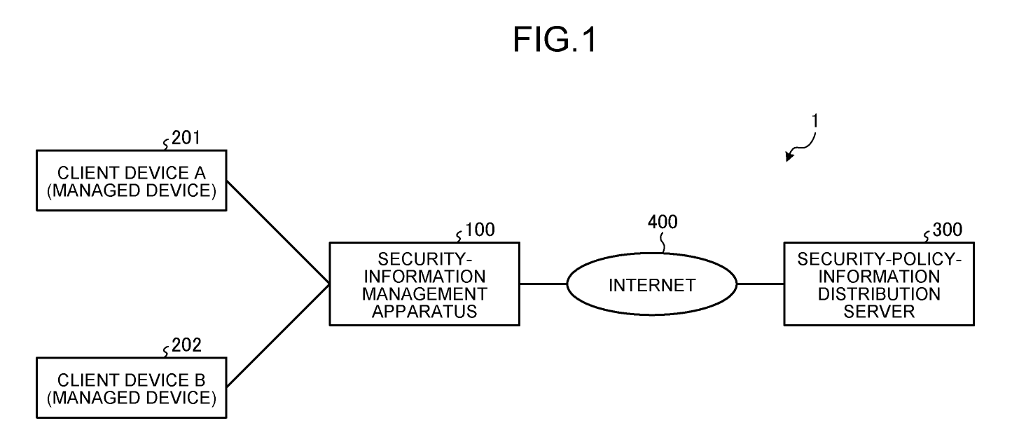

A system configuration of an information management system including an information management apparatus according to a present embodiment is described first. FIG. 1 is a system configuration diagram of the information management system including the information management apparatus according to the present embodiment.

A security-information management apparatus 100, which is an example of the information management apparatus included in an information management system 1 according to an embodiment of the present invention, is placed in a user's LAN (Local Area Network). A plurality of client devices (A_201 and B_202) (hereinafter, sometimes collectively referred to as “the managed devices”) placed in the LAN are registered on the security-information management apparatus 100. The managed devices and the security-information management apparatus 100 may be connected over a network other than the LAN.

Security setting values of the registered client devices A_201 and B_202 can be changed upon instruction from the security-information management apparatus 100. A security-policy-information distribution server 300 is connected to the security-information management apparatus 100.

The security-information management apparatus 100 and the security-policy-information distribution server 300 are connected via the Internet denoted by 400. The security-policy-information distribution server (hereinafter, sometimes simply referred to as “the server”) 300 issues a request for changing security policy information to the security-information management apparatus 100. Upon receiving the request, the security-information management apparatus 100 conducts security management in accordance with a notified security policy.

The number of the security-information management apparatuses 100 connected to the server 300 is one in FIG. 1; however, alternatively, the number of security-information management apparatuses connected to the server 300 may be two or more. The security-information management apparatus 100 and the security-policy-information distribution server 300 may be connected via a network other than the Internet.

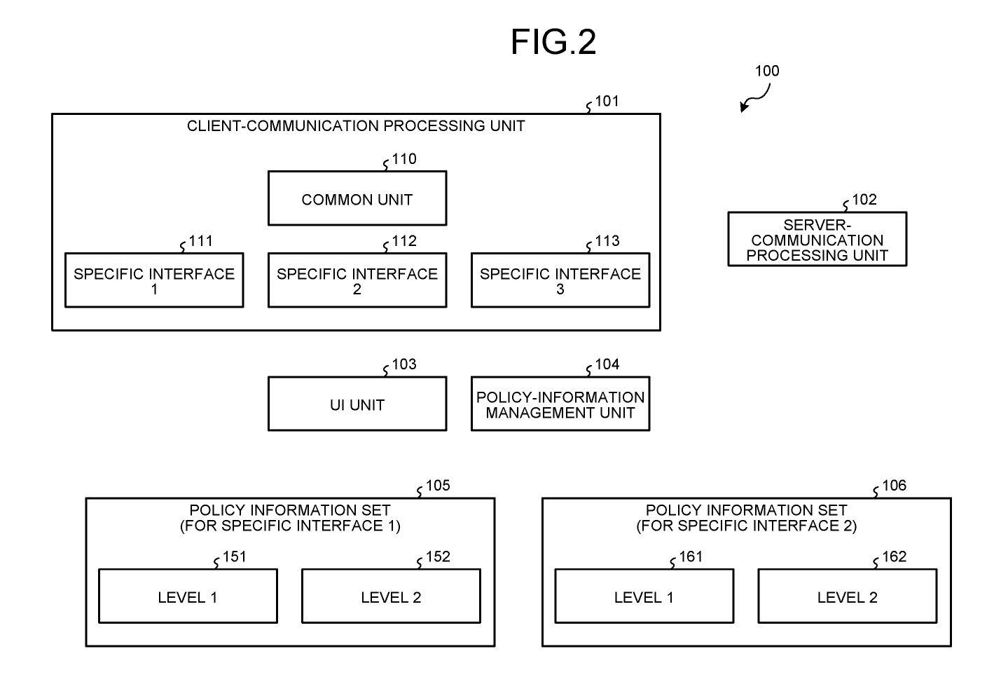

An internal configuration of the information management apparatus according to the present embodiment is described below. FIG. 2 is a functional block diagram illustrating the internal configuration of the information management apparatus according to the present embodiment. The security-information management apparatus 100, which is an example of the information management apparatus according to the embodiment of the present invention, includes a server-communication processing unit 102 and a client-communication processing unit 101. The security-information management apparatus 100 further includes a policy-information management unit 104, a user interface (UI) unit 103, and policy information sets (hereinafter, sometimes referred to as “the policy information”) 105 and 106.

The server-communication processing unit 102 performs communication with the security-policy-information distribution server 300. The client-communication processing unit 101 includes a plurality of specific interfaces (1_111, 2_112, and 3_113) that make up a specific unit, and a common unit 110. The common unit 110 has an interface common among the client devices. The specific interface 1_111, 2_112, 3_113 is dynamically added or changed upon instruction given from the server 300. This will be described later.

The policy-information management unit 104 keeps track of what changes have been made to the security-information management apparatus 100 and has a function of dynamically creating a policy table. The UI unit 103 includes a user interface for displaying policy table information to a user and a user interface for creating a request based on a user's access to the displayed policy table information.

The security-information management apparatus 100 includes the plurality of policy information sets (105 and 106) that are dynamically changed. The policy information set 105 is a list of per-function security setting values (level 1_151 and level 2_152) for the specific interface 1. The policy information set 106 is a list of per-function security settings values (level 1_161 and level 2_162) for the specific interface 2. Though the security setting values of the two levels are defined in a single policy information set in FIG. 2, the number of levels can be increased to three or greater. This will be described later. Note that policy information for the specific interface 3_113 of the client-communication processing unit 101 is omitted in FIG. 2.

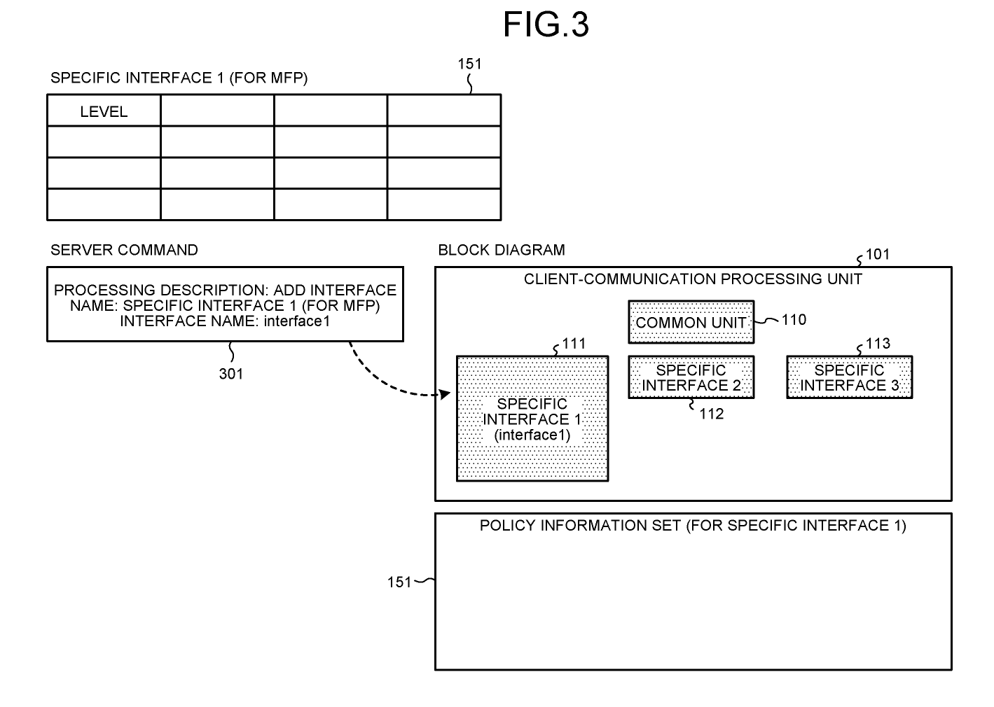

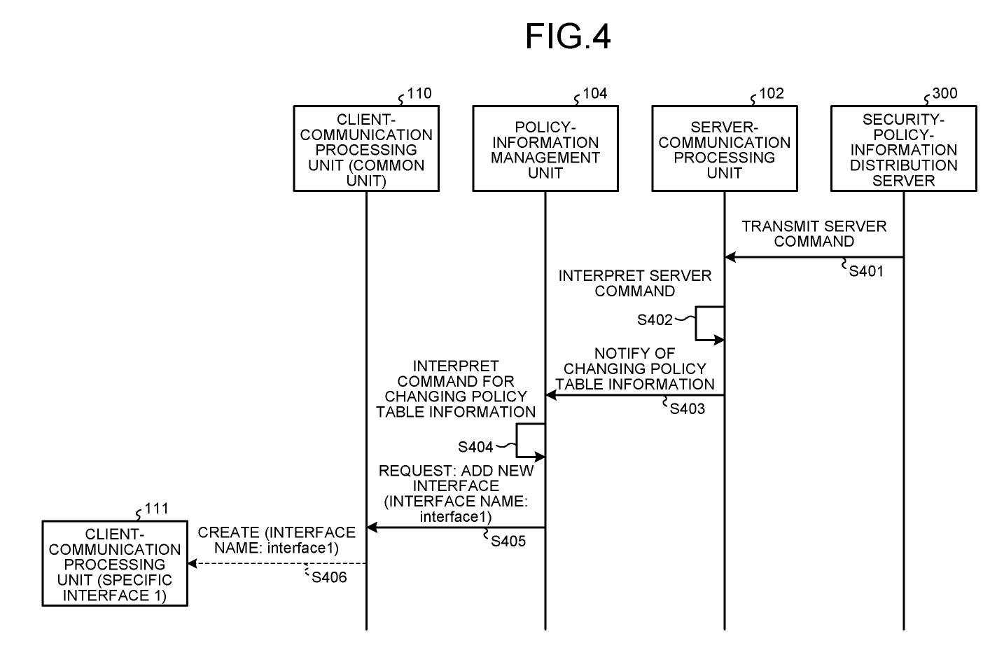

Operations to add a new interface performed by the information management apparatus according to the present embodiment are described below. FIG. 3 is a block diagram describing the operations to add a new interface performed by the information management apparatus according to the present embodiment. FIG. 4 is a sequence diagram describing the operations to add a new interface performed by the information management apparatus according to the present embodiment.

The present embodiment allows adding an interface. Specifically, the present embodiment allows creating a communication processing unit to manage a device of a new type. The security-policy-information distribution server 300 transmits a server command 301 to the server-communication processing unit 102 (step S401 of FIG. 4). Necessary data is contained in the server command 301 such that “add interface”, “specific interface 1 (for MFP)”, and “interface1” are recorded in the server command 301 as processing description, an interface to be added, and the name of the interface to be added, respectively.

The server-communication processing unit 102 interprets the command fed from the server 300 (step S402). The command fed from the server 300 can include a request other than a request requesting for changing policy table information. However, because such a request is not essential throughout the present embodiment described below, detailed description about such a request is omitted.

When a result of interpreting the command fed from the server 300 is that the command is a request for changing policy table information, the server-communication processing unit 102 notifies the policy-information management unit 104 that the policy table information be changed (step S403). The policy-information management unit 104 interprets the command for changing the policy table information received via the server-communication processing unit 102 (step S404). The policy-information management unit 104 requests the common unit 110 of the client-communication processing unit 101 to add a new interface (step S405).

The name of the new interface to be added in this example is “interface1”. Upon being requested to add the new interface, the common unit 110 of the client-communication processing unit 101 creates, as a new corresponding specific interface, the specific interface 1_111 of the client-communication processing unit 101 (step S406).

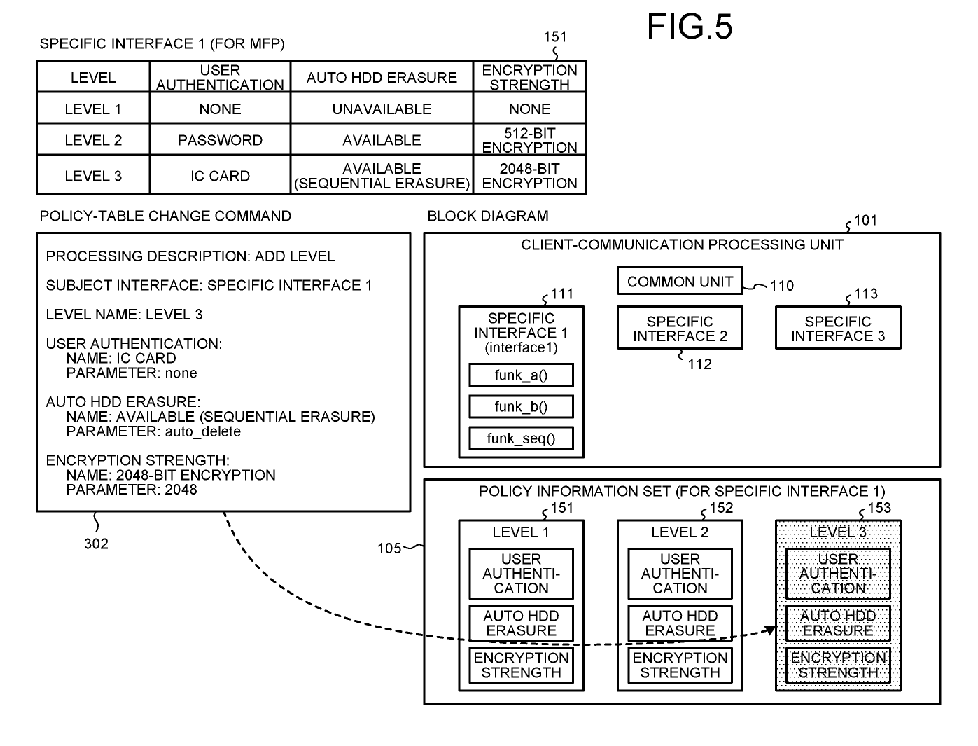

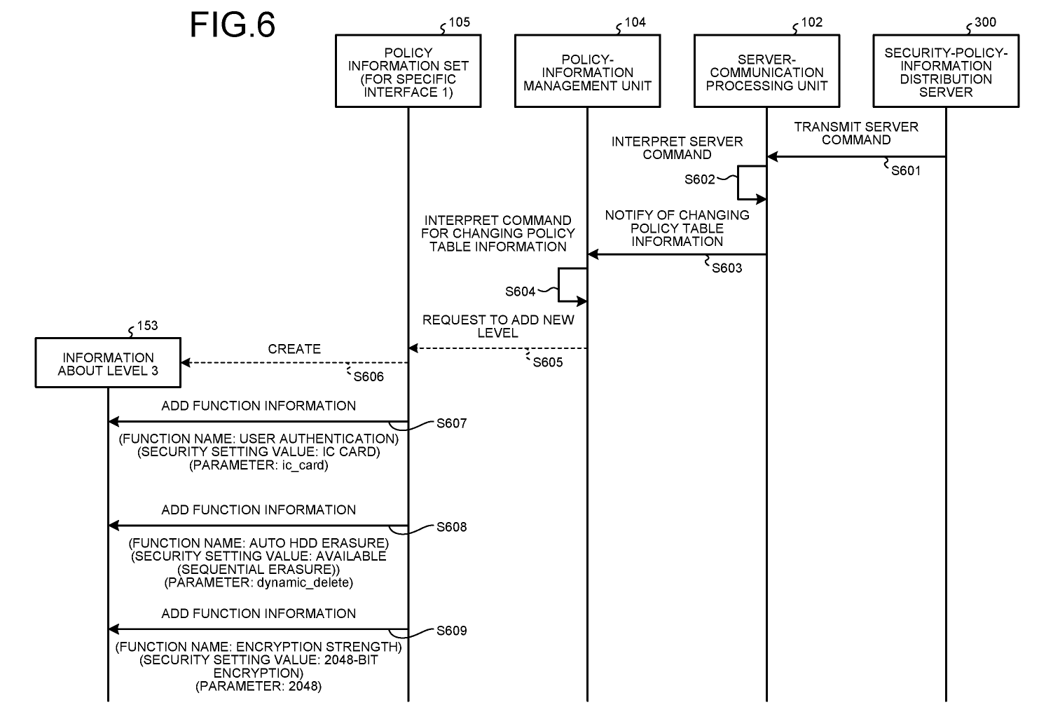

Operations to add a new security level performed by the information management apparatus according to the present embodiment are described below. FIG. 5 is a block diagram describing the operations to add a new security level performed by the information management apparatus according to the present embodiment. FIG. 6 is a sequence diagram describing the operations to add a new security level performed by the information management apparatus according to the present embodiment.

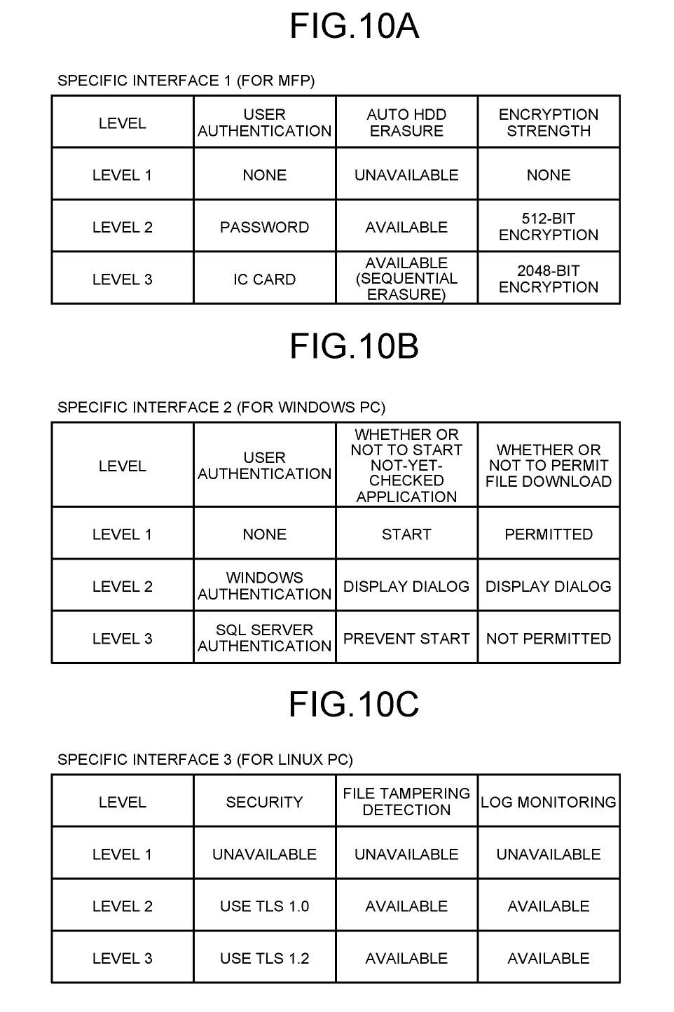

In this example, a process of adding a security level to an existing interface (policy information set) is performed. Policy tables of the information management apparatus according to the present embodiment are described below. FIG. 10A, FIG. 10B, and FIG. 10C are diagrams describing the policy tables of the information management apparatus according to the present embodiment. As illustrated in FIG. 10A, FIG. 10B, and FIG. 10C, policy tables are provided on a per-specific-interface basis (on a per-type basis of the managed devices) in the present embodiment.

As described above with reference to FIG. 2, in the present embodiment, the client-communication processing unit 101 includes the three specific interfaces (1_111, 2_112, and 3_113) as the specific unit. As illustrated in FIG. 10A, the specific interface 1_111 is assigned to a specific interface for an MFP. As illustrated in FIG. 10B, the specific interface 2_112 is assigned to a specific interface for a Windows (registered trademark) PC. As illustrated in FIG. 10B, the specific interface 3_113 is assigned to a specific interface for a Linux (registered trademark) PC.

The policy information sets 105 and 106 are defined for the specific interfaces, respectively. As functions for the specific interface 1 assigned to MFP of FIG. 10A, whether or not to perform user authentication, whether or not an automatic HDD (Hard Disk Drive) erasure function is available, presence/absence of encryption, and encryption strength, are defined for each of security level values and associated therewith.

For the specific interface 2 assigned to Windows PC of FIG. 10B, whether or not to perform user authentication, whether or not to start not-yet-checked application, and whether or not to permit file download are defined for each of the security level values and associated therewith. For the specific interface 3 assigned to Linux PC of FIG. 10C, whether or not a security function is available, whether or not file tampering detection is available, and whether or not log monitoring is available, are defined for each of the security level values and associated therewith.

In short, a function(s) necessary to provide a corresponding client device with security and security setting values of the function(s) are defined in a policy table for an interface specific to the client device. In the policy table, each function is associated with one of the security setting values for each of security levels.

Referring back to FIG. 5 and FIG. 6, a process of adding policy information representing values of security level 3 to the policy information set 105, in which values of security level 1 and security level 2 are already contained, for the specific interface 1 is described below. Specifically, the security-policy-information distribution server 300 transmits the server command 301 to the server-communication processing unit 102 (step S601 of FIG. 6). Such a policy-table change command 302 as that illustrated in FIG. 5 is contained in this server command.

In the policy-table change command 302, “add security level” and “specific interface 1” are recorded as processing description and a subject interface, respectively. In the same, “Level 3” is recorded as a security level. In the same, “IC (Integrated Circuit) card” (whose parameter is “none”) is recorded for the function name “User authentication”. In the same, “available (sequential erasure)” (whose parameter is “auto_delete”) is recorded for the function name “Auto HDD erasure”. In the same, “2048-bit encryption” (whose parameter is “2048”) is recorded for the function name “Encryption strength”.

The server-communication processing unit 102 interprets the command fed from the server 300 (step S602). When a result of interpreting the command fed from the server 300 is that the command is a request for changing policy table information, the server-communication processing unit 102 notifies the policy-information management unit 104 that the policy table information be changed (step S603). The policy-information management unit 104 interprets the command for changing the policy table information received via the server-communication processing unit 102 (step S604). The policy-information management unit 104 requests the policy information set 105 for the specific interface 1 to add a new security level (step S605).

The new security level to be added in this example is information about level 3_153. Upon being requested to add the new security level, the policy information set 105 for the specific interface 1 creates the information about level 3_153 (step S606). The policy information set 105 for the specific interface 1 performs function-information addition of adding a security setting value “IC card” to the function name “User authentication” by using the parameter “ic_card” (step S607).

The policy information set 105 also performs function-information addition of adding a security setting value “available (sequential erasure)” to the function name “Auto HDD erasure” by using the parameter “dynamic_delete” (step S608). The policy information set 105 also performs function-information addition of adding a security setting value “2048-bit encryption” to the function name “Encryption strength” by using the parameter “2048” (step S609).

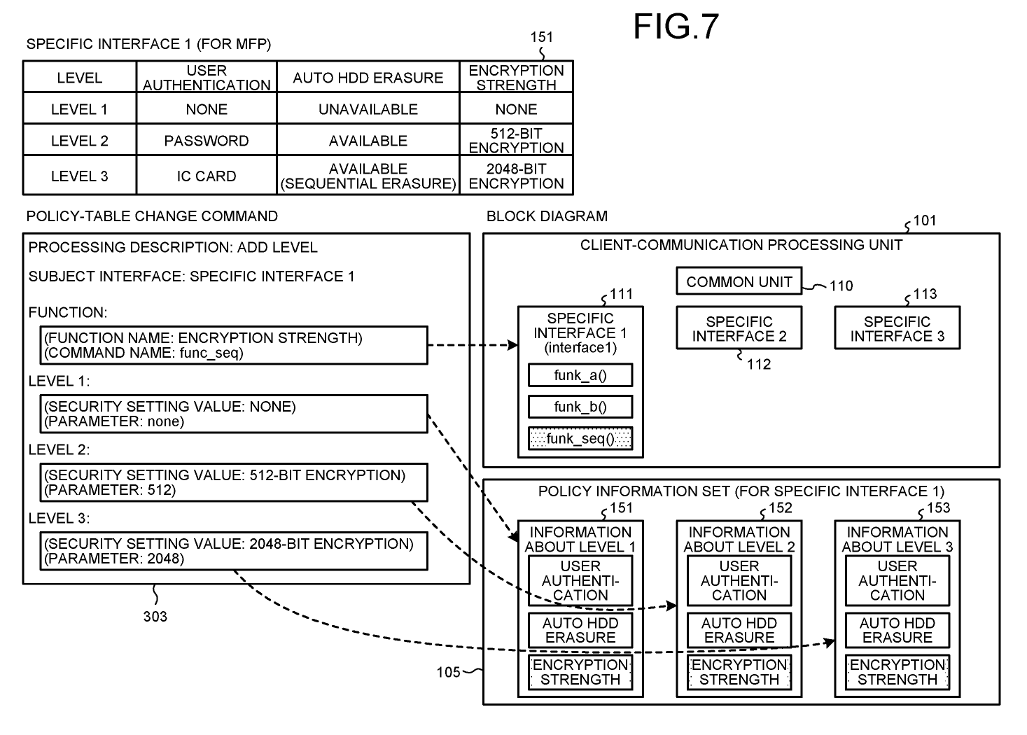

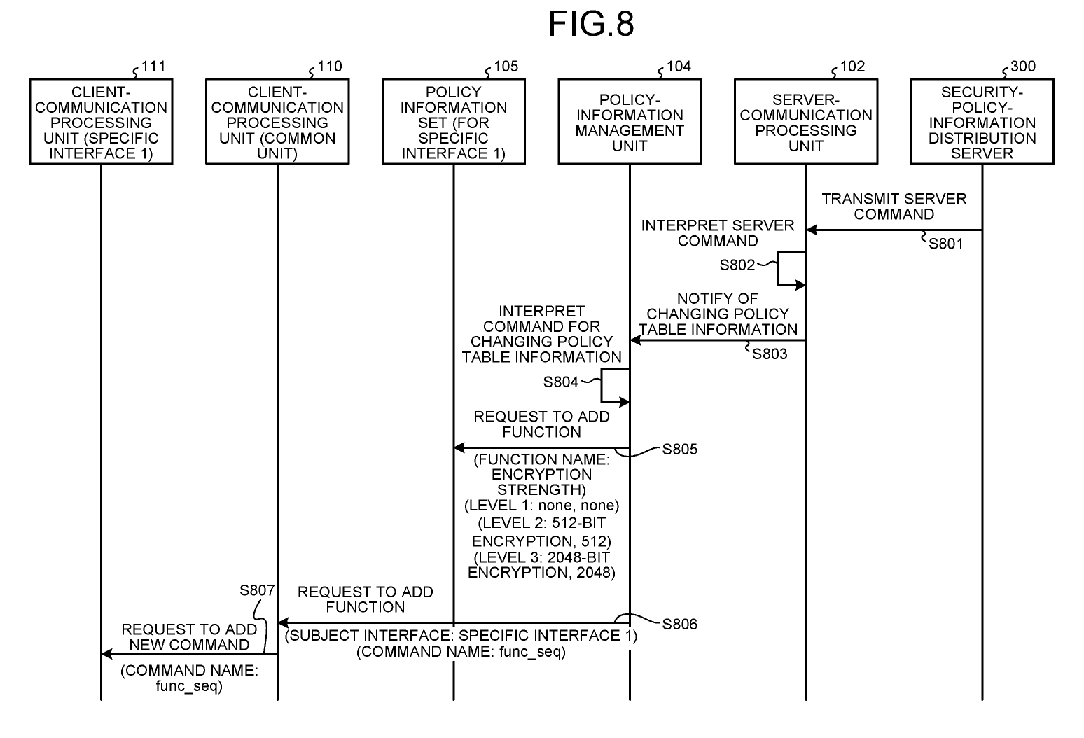

Operations to add a new function performed by the information management apparatus according to the present embodiment are described below. FIG. 7 is a block diagram describing the operations to add a new function performed by the information management apparatus according to the present embodiment. FIG. 8 is a sequence diagram describing the operations to add a new function performed by the information management apparatus according to the present embodiment.

In this example, a process of adding a new function to an existing interface (policy information set) so that security of the new function is managed by the information management apparatus is performed. This process is described through an example of adding a new function to the function name “Encryption strength” of the existing policy information set containing information for each of level 1, level 2, and level 3 for the specific interface 1 so that security of the new function is managed by the information management apparatus is described. Specifically, the security-policy-information distribution server 300 transmits a server command to the server-communication processing unit 102 (step S801 of FIG. 8). Such a policy-table change command 303 as that illustrated in FIG. 7 is recorded in this server command.

In the policy-table change command 303, “add function” and “specific interface 1” are recorded as processing description and a subject interface, respectively. In the same, the function name “Encryption strength” (whose command name is “func_seq”) is recorded. In the same, the security setting value “none” (whose parameter is “none”) is recorded for level 1. In the same, the security setting value “512-bit encryption” (whose parameter is “512”) is recorded for level 2. In the same, the security setting value “2048-bit encryption” (whose parameter is “2048”) is recorded for level 3.

The server-communication processing unit 102 interprets the command fed from the server 300 (step S802). When a result of interpreting the command fed from the server 300 is that the command is a request for changing policy table information, the server-communication processing unit 102 notifies the policy-information management unit 104 that the policy table information be changed (step S803). The policy-information management unit 104 interprets the command for changing the policy table information received via the server-communication processing unit 102 (step S804). The policy-information management unit 104 requests to add a new function to the policy information set 105 for the specific interface 1 (step S805).

The name of the new function to be added in this example is “Encryption strength”. Upon being requested to add the new function, the policy information set 105 for the specific interface 1 adds the security setting value “none” to level 1. The policy information set 105 adds the security setting value “512-bit encryption” to level 2. The policy information set 105 adds the security setting value “2048-bit encryption” to level 3. The policy-information management unit 104 requests the common unit 110 of the client-communication processing unit 101 to add a new function (step S806). An interface of the new function, addition of which is requested at step S806, is the specific interface 1_111.

Furthermore, the common unit 110 of the client-communication processing unit 101 requests the specific interface 1_111 of the client-communication processing unit 101 to add a new command (step S807). The name of the new command to be added at S807 is “func_seq”.

A new function is added to an existing interface (policy information set) so that security of the new function is managed by the information management apparatus in this manner. The policy-information management unit 104 adds a function name, a level, and a setting value to the policy information 105 (for the specific interface 1). The policy-information management unit 104 adds a specific interface 1_1111 appropriate for settings of the added function to (the common unit 110 of) the client-communication processing unit 101. The common unit 110 of the client-communication processing unit 101 instructs (the specific interface 1_111 of) the client-communication processing unit 101 to add a command appropriate for the settings of the added function.

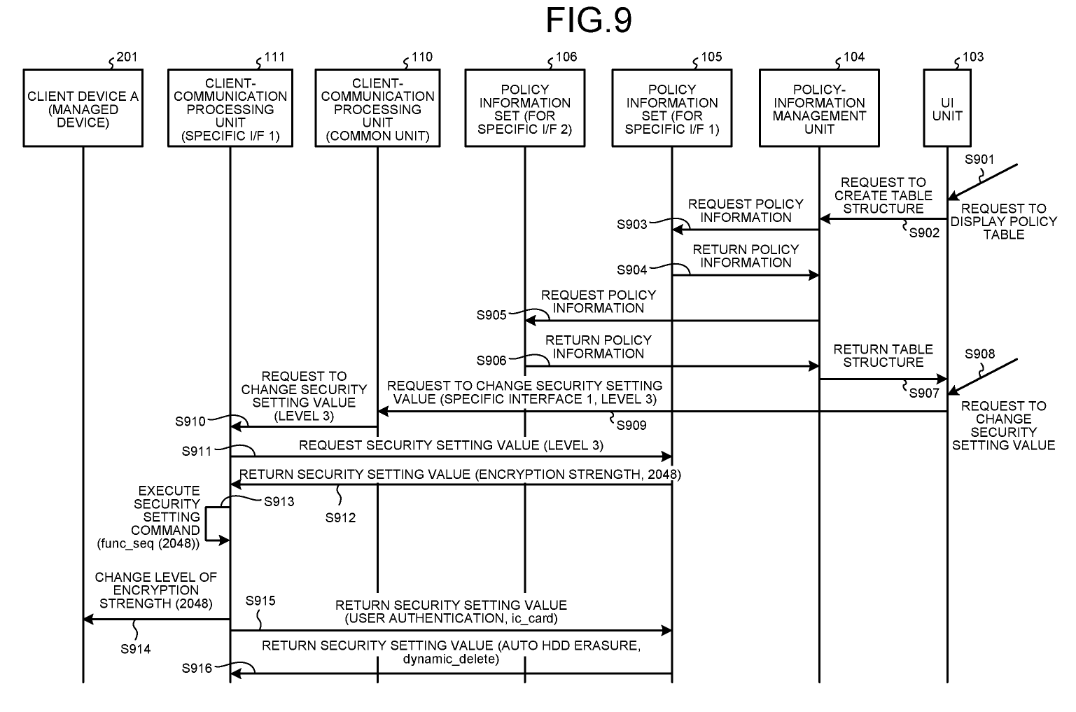

Operations to display a policy table and change a security setting value performed by the information management apparatus according to the present embodiment are described below. FIG. 9 is a sequence diagram describing the operations to display a policy table and change a security setting value performed by the information management apparatus according to the present embodiment. In this example, a process of causing the policy table to be displayed and changing a security setting value via the UI unit 103 is performed.

Operations of causing the policy table to be displayed are described first. A command for requesting to display the policy table is entered via the UI unit 103 first (step S901). The UI unit 103 requests the policy-information management unit 104 to create a table structure (step S902). The policy-information management unit 104 issues a request for policy information to the policy information set 105 for the specific interface 1 (step S903). The policy information set 105 for the specific interface 1 returns policy information as a response to the policy-information management unit 104 (step S904).

Similarly, the policy-information management unit 104 issues a request for policy information to the policy information set 106 for the specific interface 2 (step S905). In response to the request, the policy information set 106 for the specific interface 2 returns policy information as a response to the policy-information management unit 104 (step S906). The policy-information management unit 104 returns a structure of the policy table as a response to the UI unit 103 as a response (step S907).

Operations of changing a security setting value are described below. A command for changing a security setting value is entered via the UI unit 103 first (step S908). An example of changing a security setting value of level 3 for the specific interface 1 is described below. The UI unit 103 requests the common unit 110 of the client-communication processing unit 101 to change the security setting value of level 3 for the specific interface 1 (step S909).

The common unit 110 of the client-communication processing unit 101 requests the specific interface 1_111 of the client-communication processing unit 101 to change the security setting value of level 3 (step S910). The specific interface 1_111 of the client-communication processing unit 101 issues a request for the security setting value of level 3 to the policy information set 105 for the specific interface 1 (step S911). The policy information set 105 for the specific interface 1 returns the security setting value “2048-bit encryption”, which is the security setting value of level 3 of the function name “Encryption strength”, as a response to the specific interface 1_111 of the client-communication processing unit 101 (step S912).

The specific interface 1_111 of the client-communication processing unit 101 executes a security setting command using the command name “func_seq” (step S913). The specific interface 1_111 of the client-communication processing unit 101 changes the encryption strength of level 3 of the client device A (managed device) 201 to “2048-bit encryption” (step S914).

The policy information set 105 for the specific interface 1 returns, as a response, a security setting value of the function name “User authentication” by using the parameter “ic_card” (step S915). Furthermore, the policy information set 105 for the specific interface 1 returns, as a response, a security setting value of the function name “Auto HDD erasure” by using the parameter “dynamic_delete” (step S916).

The policy-information management unit 104 automatically creates the policy table information to be displayed on the UI unit 103 in this manner. Changing a security setting value requested via the UI unit 103 can be implemented by specifying a security level. (The specific interface 1_111) of the client-communication processing unit 101 and the policy information set 105 (for the specific interface 1) exchange information, thereby determining which security setting value is to be applied to which function based on the security level.

FIG. 9 describes an example where a security setting value of level 3 for the specific interface 1 is changed. When a security setting value of the specific interface 2 is to be changed, the determination is made by the specific interface 2_112 of the client-communication processing unit 101 and the policy information set 106 for the specific interface 2 by exchanging information.

As described above, in the present embodiment, a policy table for managing security setting values of a client device can be dynamically changed. Specifically, interface information, which is for use in processing communication, and security policy information, in which each of security functions is associated with one of security setting values for each of security levels, are changeable. The policy table is automatically created based on the security policy information. The present embodiment can thus provide an information management apparatus that offers increased convenience and extensibility by flexibly configuring security settings of client devices, security of which is managed by the information management apparatus, to adapt to new management requirement.

The client-communication processing unit 101 that performs communication with client devices, which are managed devices, includes the common unit 110, and the specific unit made up of the specific interfaces 1_111, 2_112, and 3_113. The specific unit is dynamically extensible based on information received from the security-policy-information distribution server 300. This configuration enables, for example, a security-information management apparatus supporting only Windows clients to support Linux clients as well. As a result, because security can be extended to cover a new client device flexibly, convenience is increased.

Furthermore, it is possible to dynamically add a policy table, which is prepared for each type of the client devices, based on information received from the security-policy-information distribution server 300. Accordingly, it is possible to manage client devices by using different policy tables even when the client devices have a same communication interface.

Furthermore, it is possible to dynamically add a security level contained in policy information based on information received from the security-policy-information distribution server 300. Therefore, it is possible to change a security level flexibly depending on a user. Specifically, it is possible to flexibly adapt to users' needs that may vary such that some users desire three-level management, while some other users desire ten-level management, for example.

It is possible to dynamically add a function to a function(s) contained in the policy table based on information received from the security-policy-information distribution server 300. Accordingly, when a new security technique emerges, an existing management system can adapt to the new security technique easily.

It is possible apply a same security level easily by displaying, on the UI unit 103, a policy table and receiving an instruction to change a security setting value on a per-security-level basis with designation of a security level, rather than on a per-security-function basis.

The embodiment is described through the example where the present invention is applied to an MFP or a PC; however, applications are not limited thereto. For example, the present invention is applicable to printers, facsimiles, copiers, and other information processing apparatuses. The present invention is applicable to an image forming apparatus that uses fixing liquid, liquid other than ink in a narrow sense, or the like.

It should be noted that the embodiment is not intended to limit the scope of the present invention. The security-policy-information distribution server may have a function of storing the policy tables of the policy information and a function of creating a policy table from interface information. The security-information management apparatus may have a function of storing the policy tables of the policy information and a function of creating a policy table from interface information.

The number of the security-policy-information distribution servers included in the information management system may be two or more; in that case, the functions may be provided by any one of the servers. It should be noted that the configuration of the information management system described in the embodiment, in which the security-information management apparatus and the security-policy-information distribution server are connected, is only an example. As a matter of course, various system configuration examples can be implemented depending on usage and purpose.

Each procedure of the operations of the security-information management apparatus 100 according to the present embodiment illustrated in FIG. 4, FIG. 6, FIG. 8, and FIG. 9 may be executed by instructions on a computer. Specifically, the procedure may be executed as follows. A CPU (Central Processing Unit) included in a controller included in the security-information management apparatus loads instructions stored in a storage unit, such as a ROM (Read Only Memory). Processing steps of the instructions are sequentially executed.

Aspects of the present invention can provide an information management apparatus, an information management system, and a computer-readable recording medium that can provide increased convenience and extensibility by flexibly configuring security settings of client devices, security of which is managed by the information management apparatus, to adapt to new management requirement.

According to an aspect of the present invention, an information management apparatus that can provide increased convenience and extensibility by flexibly configuring security settings of client devices, security of which is managed by the information management apparatus, to adapt to new management requirement can be obtained.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information management apparatus comprising:
a policy table, in which a function, the function being necessary to provide a client device with security, and security setting values of the function, the security setting values being defined depending on an interface specific to the client device, are recorded such that the function is associated with one of the security setting values for each of levels of the security;
a client-communication processing unit configured to perform communication with the client device;
a server-communication processing unit configured to communicate with a server, the server issuing a change request requesting for changing a record in the policy table; and
a policy-information management unit configured to change the record in the policy table in accordance with the change request.

2. The information management apparatus according to claim 1, wherein
the client device includes a plurality of client devices,
the client-communication processing unit includes a common unit, the common unit being an interface common among the client devices, and specific units, the specific units being interfaces respectively specific to the client devices, and
when the change request is a request requesting to add a new interface of a client device, the common unit creates the new interface based on the change request.

3. The information management apparatus according to claim 1, wherein the policy-information management unit creates a new security level based on the change request and adds a function, the function being necessary to provide security at the new security level, and security setting values of the function to the policy table.

4. The information management apparatus according to claim 1, wherein the policy-information management unit adds, to the policy table, a new function, the new function being necessary to provide the security, and security setting values of the new function for each of the security levels based on the change request.

5. The information management apparatus according to claim 1, further comprising a user interface unit configured to accept an access to the policy table by a user, wherein
when a request for displaying the policy table is accepted via the user interface unit, the policy-information management unit displays the policy table on the user interface unit.

6. The information management apparatus according to claim 5, wherein when a change request requesting for changing a security setting value of a predetermined security level is accepted via the user interface unit,
the common unit requests a corresponding one of the specific units to change the security setting value, and
the specific unit acquires a security setting value of the predetermined security level from the policy table and changes the security setting value in the policy table.

7. An information management system, in which a client device and a server are network-connected via an information management apparatus, the information management system comprising:
a policy table, in which a function, the function being necessary to provide the client device with security, and security setting values of the function, the security setting values being defined depending on an interface specific to the client device, are recorded such that the function is associated with one of the security setting values for each of levels of the security;
a client-communication processing unit configured to perform communication with the client device;
a server-communication processing unit configured to communicate with the server, the server issuing a change request requesting for changing a record in the policy table; and
a policy-information management unit configured to change the record in the policy table in accordance with the change request.

8. A non-transitory computer-readable recording medium containing instructions that, when executed by an information management apparatus including
a policy table, in which a function, the function being necessary to provide a client device with security, and security setting values of the function, the security setting values being defined depending on an interface specific to the client device, are recorded such that the function is associated with one of the security setting values for each of levels of the security,
a client-communication processing unit configured to perform communication with the client device, and
a server-communication processing unit configured to communicate with a server, the server issuing a change request requesting for changing a record in the policy table,
cause the information management apparatus to perform processing comprising changing the record in the policy table in accordance with the change request.
